(19) United States
(12) Patent Application Publication
(10) Pub. No.: US 2004/0207649 A1
(43) Pub. Date: Oct. 21, 2004

(54) Black image insertion method and apparatus for display

(76) Inventor: Po-Sheng Shih, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/692,903

(22) Filed: Oct. 24, 2003

(30) Foreign Application Priority Data
Apr. 17, 2003 (TW) 92108984

(51) Int. Cl. G09G 5/10

(52) U.S. Cl. 345/690

(57) ABSTRACT

A black image transistor and a black image line are added into a liquid crystal pixel circuit to control the insertion of black images. Moreover, a gate driver IC that can separately send two signals is used to switch the switching transistor and black image transistor, and there is a time offset between the two signals.

### BACKGROUND OF THE INVENTION

1. Field of Invention

The present invention relates to liquid crystal display. More particularly, the present invention relates to black image insertion method and apparatus for display.

2. Description of Related Art

Liquid crystal display (LCD) has many advantages over other conventional types of displays including high display quality, small volume occupation, light weight, low driving voltage and low power consumption. Hence, LCDs are widely used in small portable televisions, mobile telephones, video recording units, notebook computers, desktop monitors, projector televisions and so on. Therefore, LCDs have gradually replaced the conventional cathode ray tube (CRT) as a mainstream display unit. In particular, the market is mainly occupied by the TFT-LCD due to the high display quality and the low consumption power of the TFT-LCD.

FIG. 1A is a circuit diagram of a conventional liquid crystal pixel 100. A scanning line 102 periodically switches a switching transistor 112 with enable pulses. When the switching transistor 112 is switched on, a data line 104 writes pixel data into a pixel cell 114 through the switching transistor 112. A first electrode of the pixel cell 114 is connected to the switching transistor 112, and a second electrode of the pixel cell 114 is connected to the common voltage (V_{com}). The common voltage is equal to a voltage of a common line 106.

The circuit further has a storage capacitor 116. One electrode of the storage capacitor 116 is connected to the switching transistor 112, and the other electrode of the storage capacitor 116 is connected to the common line 106. Electric charges stored in the storage capacitor 116 are used to compensate for a leakage current of the pixel cell 114, keeping the voltage of the whole liquid crystal pixel 100 stable.

The enable pulses switching the switching transistor 112 are generally generated by a gate driver IC 120, as illustrated in FIG. 1B. The gate driver IC 120 has n gate pins 122 (G₁-Gₙ) connected to n scanning line 102 of the liquid crystal display, and sequentially switches n switching transistors 112 respectively coupled to n scanning line 102.

Generally speaking, manufacturers use several techniques to make the visual effect of liquid crystal displays better. The brightness displayed by a liquid crystal display is kept the same during a whole frame time, and variations of colors displayed by the liquid crystal display therefore are not sharp. A technique for improving this problem is to insert a black image between two adjacent frames, variations of colors displayed by sequential frames thus looks clearer, and the liquid crystal display becomes sharper.

Inserting a black image between two adjacent frames requires a frequency of a data driver IC in charge of sending pixel data to double. The high-frequency data driver IC is not only hard to produce but also has a problem of a lack of enough time to send pixel data to liquid crystal pixels.

A conventional method for inserting black image is described in “A Novel Wide-Viewing-Angle Motion-Picture LCD, SID '98” published by IBM Japan, and is illustrated in FIG. 2A. A liquid crystal display 200 is divided into an upper screen 202 and a lower screen 204. The two screens receive pixel data respectively from data driver IC 212 and 214, and a gate driver IC 216 controls the receiving order of the upper screen 202 and lower screen 204.

This technique published by IBM Japan uses two data driver ICs to improve the problem of high-frequency of the data driver IC. However, a disadvantage of the technique is that two driver ICs increase cost. Moreover, a black-insert-ratio of the technique is fixed at 50%, a half display time of the liquid crystal display must be dark, the average brightness of the liquid crystal display therefore is lower, and the efficiency of the liquid crystal display also deteriorates.

Another technique for inserting black image is described in “A Black Stripe Driving Scheme for Displaying Motion Pictures on LCDs, SID '01” published by NEC Corp, and illustrated in FIG. 2B. A time gap between enable pulses 222 and 224 controlling two adjacent scanning line is defined as an enable pulse 226 to control sending of black image data.

Since the pulse time of the enable pulse 226 is too short to make a liquid crystal pixel be totally dark at a single time, several enable pulses are consequently used to send black image data, so as to certainly make the liquid crystal pixel be totally dark. However, this circuit is very complicated, and a frequency of the data driver IC must very high to send multiple black image data. This is very hard to produce.

In addition, large-sized liquid crystal displays cannot use this technique because of heavy RC delay, and high-resolution liquid crystal displays also cannot use the technique because of too many data lines. These two types of liquid crystal displays both have a problem of a lack of enough time for bending the liquid crystals.

### SUMMARY OF THE INVENTION

It is therefore an objective of the present invention to provide a black image insertion method and apparatus for display to improve the problem of inserting black images in a liquid crystal display.

It is another an objective of the present invention to provide a black image insertion circuit for display. The circuit having a black image transistor and a black image line makes the pixel cell present a dark state.

It is still another an objective of the present invention to provide a gate driver IC. The gate driver IC commands the switches and the voltages of the switching transistor and the black image transistor to insert a black image between two frames in a liquid crystal display.

It is still another an objective of the present invention to provide a liquid crystal display having a black image circuit. The circuit is simple, available with one gate driver IC and one data driver IC, and does not generate a problem when inserting black images because of RC delay or too many data lines.

In accordance with the foregoing and other objectives of the present invention, a black image insertion method and apparatus are described. The invention attaches a black image transistor to the conventional liquid crystal circuit to control the black image insertion and cooperate with a gate driver IC sending two enable signals to switch separately a switching transistor and the black image transistor. Moreover, the gate driver IC also can control an equivalent diode, formed by shorting a source and a gate of the black image transistor, to make a crystal pixel present a dark state. A black image is thus displayed on the liquid crystal display.

The gate driver IC has gate pins and black image pins. The gate pin is connected to the scanning line to switch the switching transistor, and the black image pin is connected to the black image line to switch the black image transistor and modify the voltage of the black image line. The gate driver IC respectively sends two enable pulses from the gate pins and the black image pins.

In addition, a time offset exists between the two enable pulses, periods of which are not necessarily equal. When the periods of the enable pulses of the black image line and the scanning line are equal, one black image is inserted within every frame. In other words, the frames and the black images are interlaced in a one-to-one relation. Nonetheless, the periods of the enable pulses of the black image line and the scanning line are unequal in some other operating conditions. In those operating conditions, one black image is inserted after several frames and the frames and the black images are Interlaced in a many-to-one relation.

When the circuit is operating, the gate pin first sends an enable pulse to the switching transistor, pixel data are thus written into the pixel cell, and the black image pin must not turn on the black image transistor at this time. Subsequently, a black image enable pulse sent by the black image pin switches on the black image transistor and the pixel cell therefore presents a dark state because of a voltage of a first electrode of the pixel cell is between the common voltage V_{com} plus a zero-level gray scale voltage and the common voltage V_{com} minus the zero-level gray scale voltage.

According to one preferred embodiment of the invention, a gate of the black image transistor is connected to a black image line, a source of the black image transistor is connected to a common line, and a drain of the black image transistor is connected to a pixel cell.

According to another preferred embodiment of the invention, a gate and a source of the black image transistor are connected to a black image line, and a drain of the black image transistor is connected to a pixel cell.

According to another preferred embodiment of the invention, a drain of the black image transistor is connected to a black image line, and a gate and a source of the black image transistor are connected to a pixel cell.

In conclude, the invention is carried out only with one gate driver IC and one data driver IC, and the frequencies of these two driver ICs need not be raised. The problem of difficulty in producing the ICs because of their high frequency is thus avoided. The starting time point of the black image enable pulse that makes the pixel cell present a dark state can be arbitrarily adjusted, so the black-insert-ratio is not fixed at 50% as in the prior art. Liquid crystal displays utilizing the invention do not sacrifice half their brightness, and the efficiency of liquid crystal displays is thus improved.

Moreover, the circuit design in the invention is simple and adjustable. The invention is also useful for large-sized liquid crystal displays having heavy RC delay and high-resolution liquid crystal displays having too many data lines. The invention provides a black image insertion method and apparatus suitable for large-sized or high-resolution liquid crystal displays.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A is a circuit diagram of a conventional liquid crystal pixel;

FIG. 1B is a schematic view of a conventional gate driver IC;

FIG. 2A is a schematic view of “A Novel Wide-Viewing-Angle Motion-Picture LCD, SID '98” published by IBM Japan;

FIG. 2B is a schematic view of “A Black Stripe Driving Scheme for Displaying Motion Pictures on LCDs, SID '01” published by NEC Corp.;

FIG. 3A is a circuit diagram in accordance with one embodiment of the invention;

FIG. 3B is a schematic view of a gate driver IC in accordance with one embodiment of the invention;

FIG. 3C is a graph of voltage versus time in accordance with one embodiment such as the circuit in FIG. 3A in operation;

FIG. 3D is a graph of the many-to-one relation of the enable pulses of the scanning line and the black image line;

FIG. 3E is a graph of voltage versus time in accordance with another embodiment such as the circuit in FIG. 3A in operation.

FIG. 4A is a circuit diagram in accordance with another embodiment of the invention;

FIG. 4B is an equivalent circuit diagram of FIG. 4A;

FIG. 4C is a graph of voltage versus time in accordance with one embodiment such as the circuit in FIG. 4A in operation;

FIG. 5A is a circuit diagram in accordance with another embodiment of the invention;

FIG. 5B is an equivalent circuit diagram of FIG. 5A; and

FIG. 5C is a graph of voltage versus time in accordance with one embodiment such as the circuit in FIG. 5A in operation.

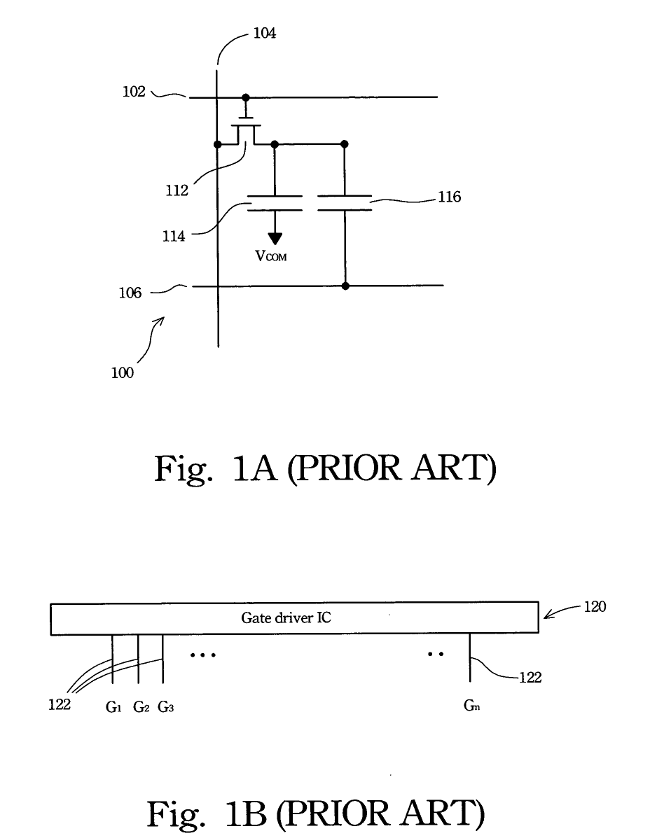

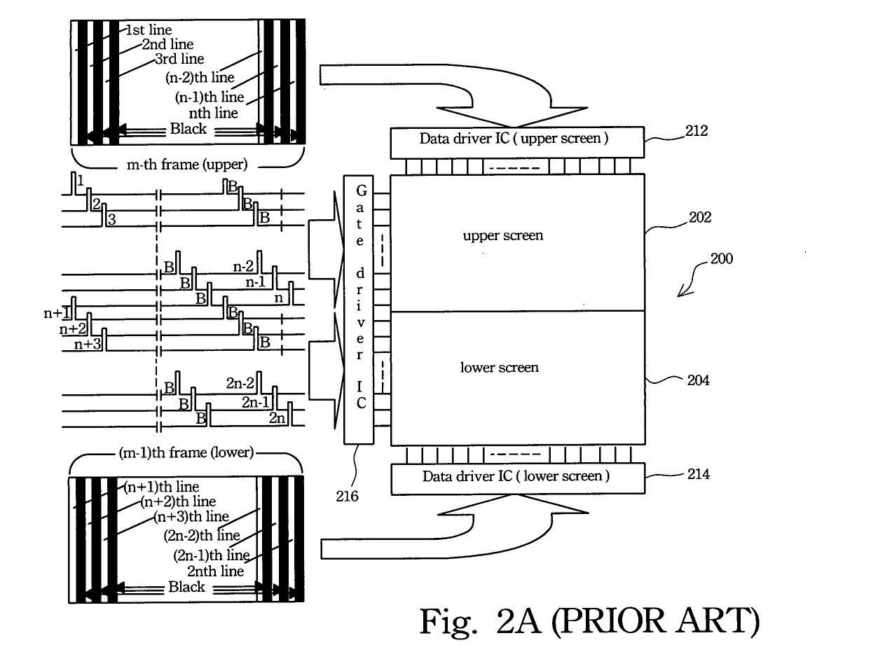

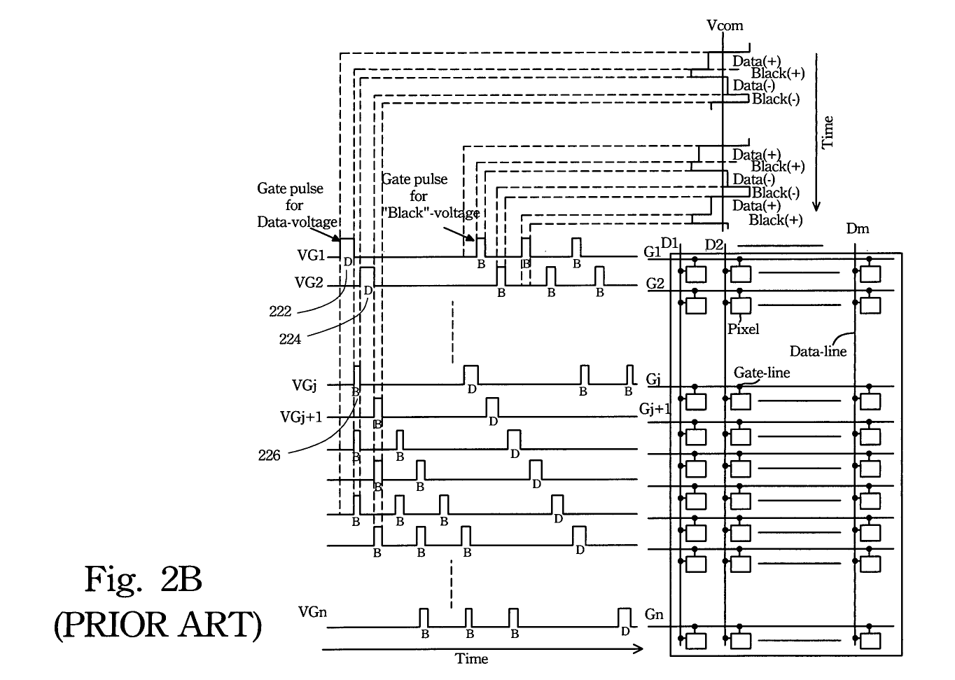

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention provides black image insertion method and apparatus for display to improve the problem of inserting black images in a liquid crystal display.

The invention attaches a black image transistor to the conventional liquid crystal circuit to control the black image insertion, and cooperate with a gate driver IC sending two enable signals to switch a switching transistor and the black image transistor separately. Moreover, the gate driver IC also can control an equivalent diode, formed by shorting a source and a gate of the black image transistor, to make a crystal pixel present a dark state. A black image is therefore displayed on the liquid crystal display.

### The First Embodiment

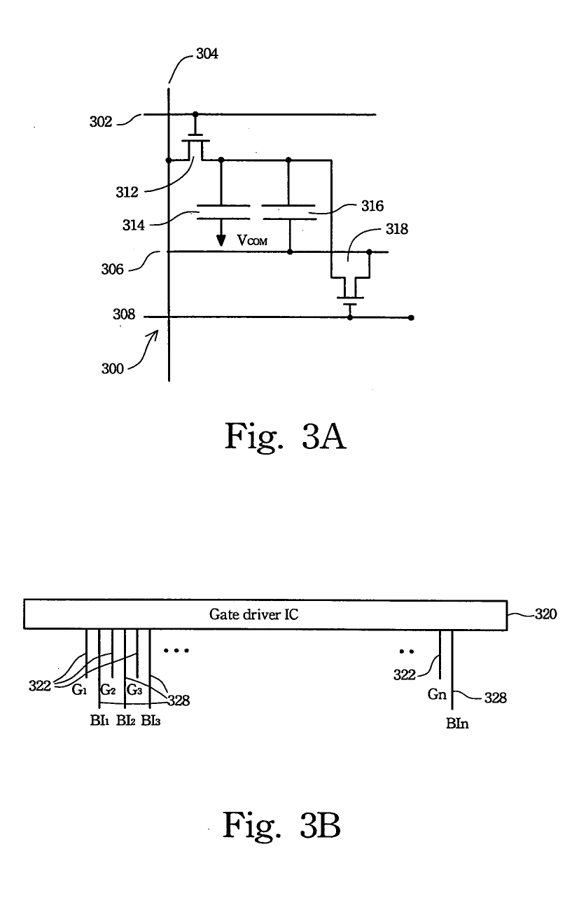

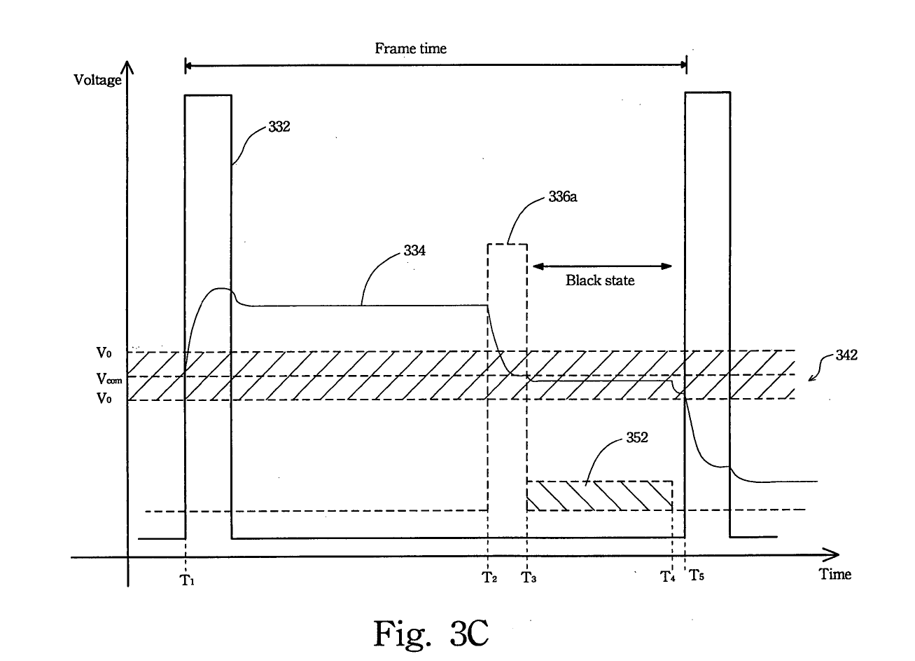

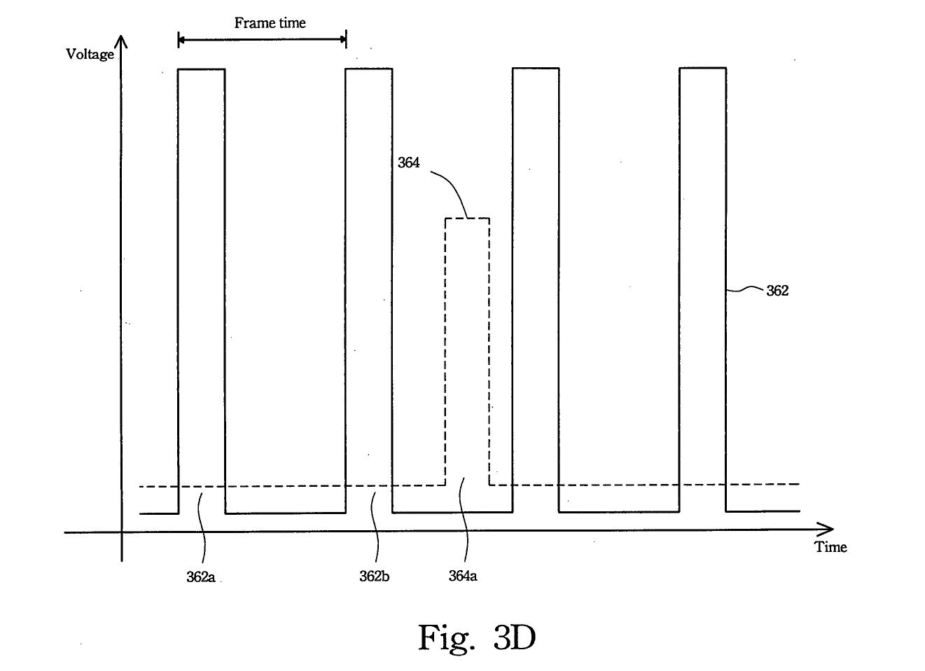

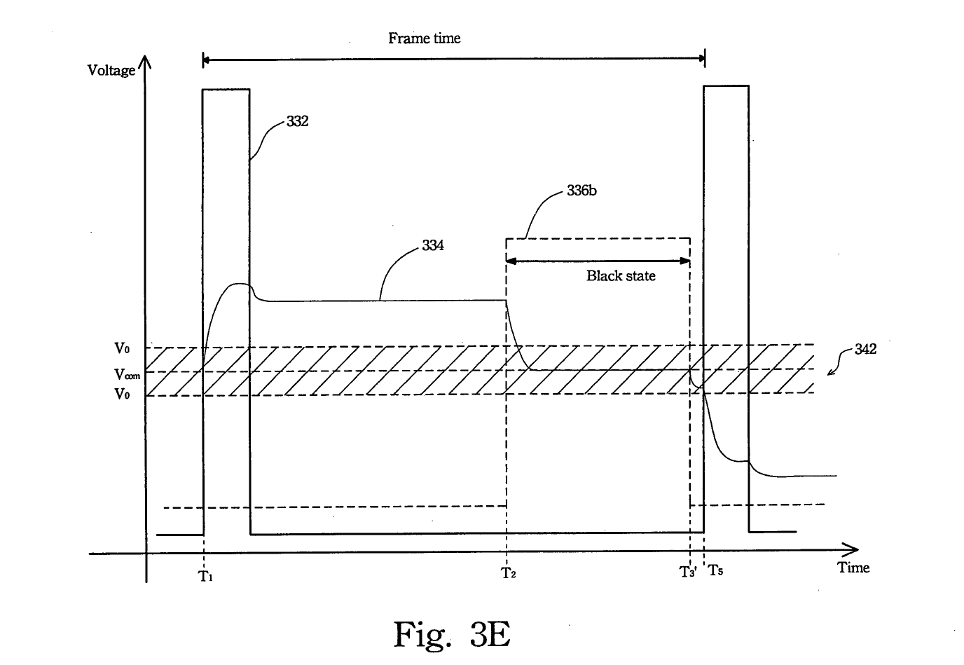

FIG. 3A illustrates a circuit diagram of one preferred embodiment of the invention. A scanning line 302 periodically switches a switching transistor 312 with enable pulses. When the switching transistor 312 is switched on, a data line 304 writes pixel data into a pixel cell 314 through the switching transistor 312.

A first electrode of the pixel cell 314 is connected to the switching transistor 312, and a second electrode of the pixel cell 314 is connected to the common voltage (V_{com}). The common voltage is equal to a voltage of a common line 306. Furthermore, one electrode of a storage capacitor 316 is connected to the switching transistor 312, and the other electrode of the storage capacitor 316 is connected to the common line 306.

The invention adds a black image transistor 318 and a black image line 308 into the foregoing circuit. A gate of the black image transistor 318 is connected to the black image line 308, a source of the black image transistor 318 is connected to the common line 306, and a drain of the black image transistor 318 is connected to the first electrode of the pixel cell 314.

By this configuration, when a black image pulse is sent from the black image line 308 to the gate of the black image transistor 318, the drain and source of the black image transistor 318 are electrically conducted, such that a voltage of the first electrode of the pixel cell 314 is pulled to a black image voltage range and the pixel cell 314 therefore presents a dark state. The black image voltage range is defined as being between the common voltage V_{com} plus a zero-level gray scale voltage and the common voltage V_{com} minus the zero-level gray scale voltage.

The invention further provides a gate driver IC. The gate driver IC controls the switching transistor 312 and black image transistor 318 through the scanning line 302 and the black image line 308, respectively, as illustrated in FIG. 3B. The gate driver IC 320 has gate pins 322 (G₁-Gₙ) and black image pins 328 (Bl₁-Blₙ). The gate pin 322 is connected to the scanning line 302 to switch the switching transistor 312, while the black image pin 328 is connected to the black image line 308 to switch the black image transistor 318 and modify the gate voltage.

The gate driver IC 320 respectively sends two enable pulses from the gate pins 322 and the black image pins 328, and therein a black image enable pulse of the black image line 308 is located between two adjacent enable pulses of the scanning line 302. In addition, the gate driver IC 320 also can control the voltages of the scanning line 302 and the black image line 308.

However, the black image insertion circuit for display is not limited to operation with the gate driver IC in this embodiment. Other gate driver ICs are also can be used in this invention if they can send a black image enable pulse of the black image line 308 between two adjacent enable pulses of the scanning line 302 and control the voltages of the black image line 308 and scanning line 302.

In addition, a time offset is designated between the two enable pulses, and periods thereof them are not necessarily equal. When the periods of the enable pulses of the black image line 308 and the scanning line 302 are equal, one black image is inserted between every two frames. In other words, the frames and the black images are Interlaced in a one-to-one relation. Nonetheless, the periods of the enable pulses of the black image line 308 and the scanning line 302 are unequal in some other operating conditions. In those operating conditions, one black image is inserted after several frames, the frames and the black images are Interlaced in many-to-one relation.

FIG. 3D is a graph for the many-to-one relation of the enable pulses of the scanning line 302 and the black image line 308. After a voltage signal 362 of the scanning line 302 presenting two enable pulses 362a and 362b, a voltage signal 364 of the black image line 308 then presents a black image enable pulse 364a. In other words, the black image line 308 sends one enable pulse (like the black image enable pulse 364a in FIG. 3D) after the scanning line 302 sending several enable pulses (like the enable pulses 362a and 362b in FIG. 3D).

Furthermore, it is noted that the display method of the many-to-one relation of the frames and the black images can be used in any embodiment of the present invention, and are not only limited to this embodiment.

FIG. 3C is a graph of voltage versus time in accordance with one embodiment such as the circuit in FIG. 3A while operating. The following descriptions refer simultaneously to FIG. 3C and FIG. 3A. At time T₁, a voltage signal 332 of the scanning line 302 sends an enable pulse to switch on the switching transistor 312, the data line 304 then sends the pixel data to the first electrode of the pixel cell 314 though the switching transistor 312, and a voltage signal 334 of the first electrode is raised to the voltage of the pixel data.

At time T₂, a voltage signal 336a of the black image line 308 sends a black image enable pulse to switch on the black image transistor 318. At this time, the drain and the source of the black image transistor 318 are electrically conducted, the voltage signal 334 of the first electrode is therefore pulled to a black image voltage range 342, and the pixel cell 314 presents a black state. The black image voltage range 342 is defined as being between the common voltage V_{com} plus a zero-level gray scale voltage and the common voltage V_{com} minus the zero-level gray scale voltage.

As illustrated in FIG. 3C, at time T₂, the voltage signal 334 of the first electrode is pulled to a black image voltage range 342. However, in some cases, the voltage of the voltage signal 336a may or may not return to the original voltage, such as area 352, before the starting time point of a next enable pulse of the voltage signal 332 at time 5. Therefore, the gate driver IC 320 has to return the voltage of the black image line 308 to the original voltage at time T₄.

At time T₅, the voltage signal 332 of the scanning line 302 sends the next enable pulse to switch on the switching transistor 312 again, and the data line 304 then sends the next pixel data to the first electrode of the pixel cell 314 through the switching transistor 312. Generally, the period of the two starting time points of the two adjacent enable pulses sent by the voltage signal 332 is called a frame time.

The foregoing black image enable pulse (at time T₂) sent by the voltage signal 336a of the black image line 308 must be between the two adjacent enable pulses, time T₁ and time T₅, sent by the voltage signal 332 of the scanning line 302. In addition, the time T₄ at which the voltage signal 336a modifies the voltage signal 334 must be earlier than the time when the next enable pulse of the voltage signal 332 starts, time T₅. All circuit conditions are therefore kept the same before any pixel data are sent to the liquid crystal pixel 300.

The voltage signal of black image line 308 circuit in FIG. 3A has other operation modes besides the one illustrated in FIG. 3C, as illustrated in FIG. 3E. FIG. 3E is a graph of voltage versus time in accordance with another embodiment exemplified by the circuit in FIG. 3A operating in another way. The main difference between the FIG. 3C and FIG. 3E is the switch-on period of the voltage signal of the black image line 308 after time T₂.

The voltage signal 336b of the black image line 308 in FIG. 3E switches on the black image transistor 318 at time T₂ and then keeps the black image transistor 318 in the switched-on state, until the black image transistor 318 is switched off at time T₃′. The voltage signal 336b is not like the voltage signal 336a in FIG. 3C, which is only a short pulse from time T₂ to time T₃.

As illustrated in FIG. 3E, at time T₂, the voltage signal 336b of the black image line 308 sends a black image enable pulse to switch on the black image transistor 318. At this time, the drain and the source of the black image transistor 318 are electrically conducted, the voltage signal 334 of the first electrode is therefore pulled to a black image voltage range 342, and the pixel cell 314 presents a black state. The black image voltage range 342 is defined as being between the common voltage V_{com} plus a zero-level gray scale voltage and the common voltage V_{com} minus the zero-level gray scale voltage.

The drain and the source of the black image transistor 318 are electrically conducted until the voltage signal 336b switches off the black image transistor 318 at time T₃′. After that, the voltage signal 332 of the scanning line 302 sends the next enable pulse to switch on the switching transistor 312 again at time T₅.

### The Second Embodiment

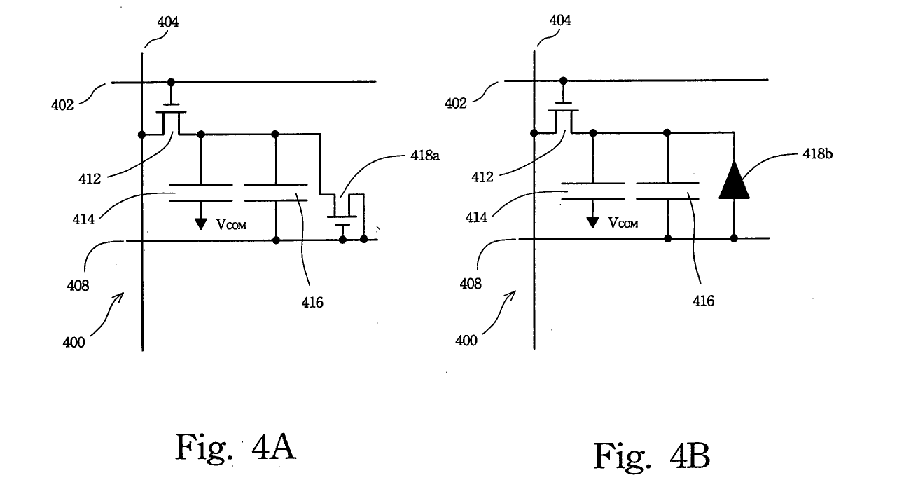

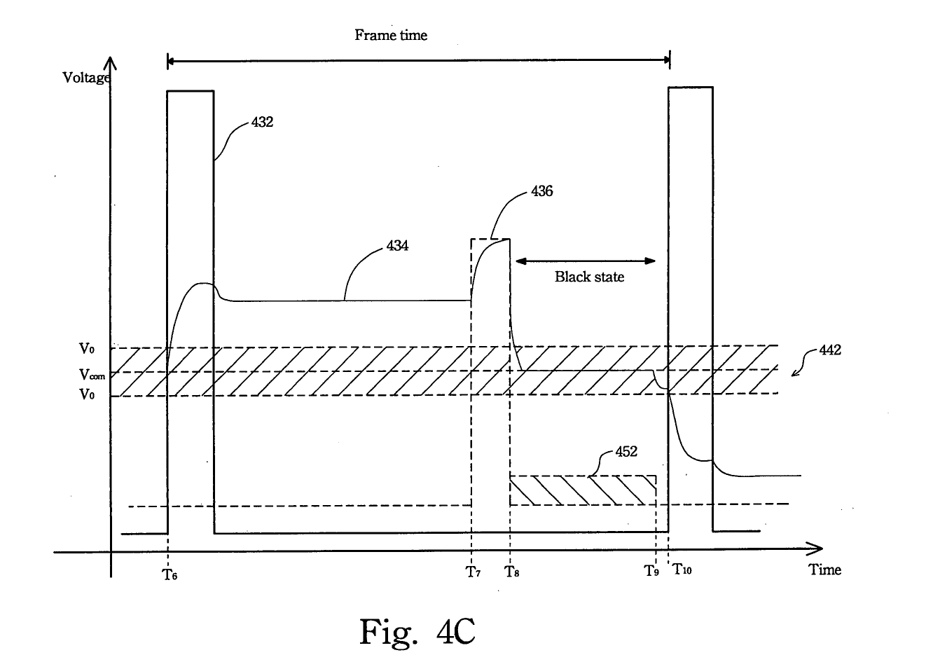

FIG. 4A illustrates a circuit diagram of another preferred embodiment of the invention. A scanning line 402 periodically switches a switching transistor 412 with enable pulses. When the switching transistor 412 is switched on, a data line 404 writes pixel data into a pixel cell 414 through the switching transistor 412.

A first electrode of the pixel cell 414 is connected to the switching transistor 412 and a second electrode of the pixel cell 414 is connected to the common voltage (V_{com}). Furthermore, one electrode of a storage capacitor 416 is connected to the switching transistor 412 and the other electrode of the storage capacitor 416 is connected to a black image line 408 of the invention.

The invention adds a black image transistor 418a and a black image line 408 into the foregoing circuit. A gate and a source of the black image transistor 418a are both connected to the black image line 408, and a drain of the black image transistor 418a is connected to the first electrode of the pixel cell 414.

By this configuration, the black image transistor 418a in circuit is equivalent to a diode 418b, as illustrated in FIG. 4B. When a black image pulse is sent from the black image line 408 to the diode 418b (i.e. the gate and the source of the black image transistor 418a) and the voltage of the black image enable pulse is higher than the voltage of the pixel data, the diodes 418b thus are turned on.

The voltage of the black image line 408 then couples with the voltage of the first electrode of the pixel cell 414 so as to pull the voltage of the first electrode of the pixel cell 414 to a black image voltage range. The pixel cell 414 therefore presents a dark state. The black image voltage range is defined as being between the common voltage V_{com} plus a zero-level gray scale voltage and the common voltage V_{com} minus the zero-level gray scale voltage.

This preferred embodiment also provides a gate driver IC as illustrated in FIG. 3B. The gate driver IC controls the switching transistor 412 and black image transistor 418a through the scanning line 402 and the black image line 408, respectively. The gate driver IC 320 has gate pins 322 (G₁-Gₙ) and black is image pins 328 (Bl₁-Blₙ). The gate pin 322 is connected to the scanning line 402 to switch the switching transistor 412, and the black image pin 328 is connected to the black image line 408 to switch the black image transistor 418a and modify the gate voltage.

The gate driver IC 320 respectively sends two enable pulses from the gate pins 322 and the black image pins 328, and a black image enable pulse of the black image line 408 is between two adjacent enable pulses of the scanning line 402. In addition, the gate driver IC 320 also can control the voltages of the scanning line 402 and the black image line 408.

However, the black image insertion circuit for display is not limited to operation with the gate driver IC as in this embodiment. Other gate driver ICs also can be used in this invention if they can send a black image enable pulse of the black image line 408 between two adjacent enable pulses of the scanning line 402, and control the voltages of the black image line 408 and scanning line 402.

FIG. 4C is a graph of voltage versus time in accordance with one embodiment as exemplified by the circuit in FIG. 4A during operation. The following descriptions refer to FIG. 4C and FIG. 4A. At time T₆, a voltage signal 432 of the scanning line 402 sends an enable pulse to switch on the switching transistor 412, the data line 404 then sends the pixel data to the first electrode of the pixel cell 414 though the switching transistor 412, and a voltage signal 434 of the first electrode is raised to the voltage of the pixel data.

It is noted that the black image transistor 418a in the circuit is equivalent to the diode 418b; the voltage signal 436 therefore must be lower than the voltage signal 434 of the first electrode so as to prevent the black image transistor 418a (i.e. the diode 418b) from being turned on.

At time T₇, a voltage signal 436 of the black image line 408 sends a black image enable pulse to switch on the black image transistor 418. The voltage of the black image enable pulse must be higher than the voltage of the pixel data. As stated above, the black image transistor 418a in the circuit is equivalent to the diode 418b. The diode 418b is therefore turned on and then the voltage signal 434 of the first electrode is then charged to about the voltage signal 436 of the black image line 408.

At time T₈, the voltage signal 434 of the first electrode is coupled to a black image voltage range 442 by the voltage signal 436 of the black image line 408, and the pixel cell 414 thus presents a black state. The black image voltage range 442 is defined as being between the common voltage V_{com} plus a zero-level gray scale voltage and the common voltage V_{com} minus the zero-level gray scale voltage.

As illustrated in FIG. 4C, at time T₈, the voltage signal 436 of the black image line 408 in this embodiment couples the voltage signal 434 of the first electrode to a black image voltage range 442. However, in some cases, the voltage of the voltage signal 436 may be unable to return to the original voltage (as illustrated by area 452 in FIG. 4C) before the starting time point of a next enable pulse of the voltage signal 432 (at time T₁₀). Therefore, the gate driver IC 320 has to return the voltage of the black image line 408 to the original voltage at time T₉.

At time T₁₀, the voltage signal 432 of the scanning line 402 sends the next enable pulse to switch on the switching transistor 412 again, and the data line 404 then sends the next pixel data to the first electrode of the pixel cell 414 through the switching transistor 412. Generally, the period of the two starting time points of the two adjacent enable pulses sent by the voltage signal 432 is called a frame time.

The foregoing black image enable pulse (at time T₇) sent by the voltage signal 436 of the black image line 408 must be between the two adjacent enable pulses (at time T₆ and time T₁₀) sent by the voltage signal 432 of the scanning line 402. In addition, the time T₉ that the voltage signal 436 modified must be earlier than the starting time point of the next enable pulse of the voltage signal 432 (at time T₁₀). All circuit conditions are therefore kept the same before any pixel data are sent to the liquid crystal pixel 400.

### The Third Embodiment

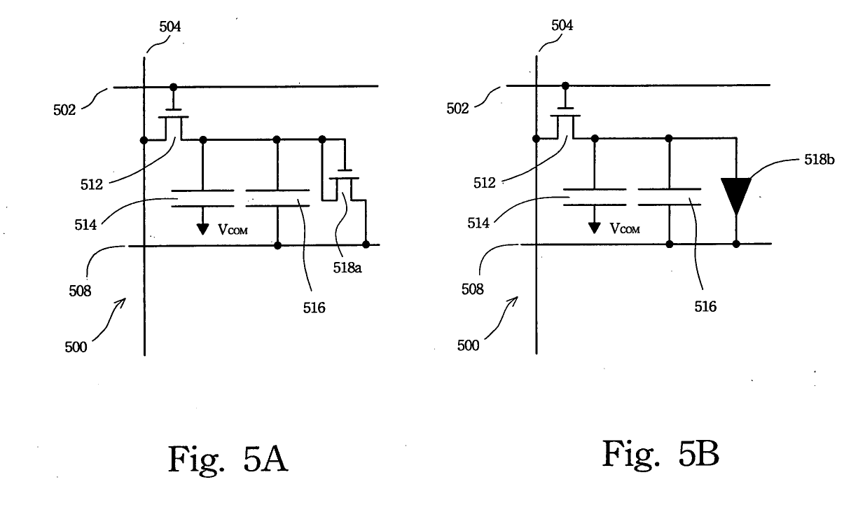

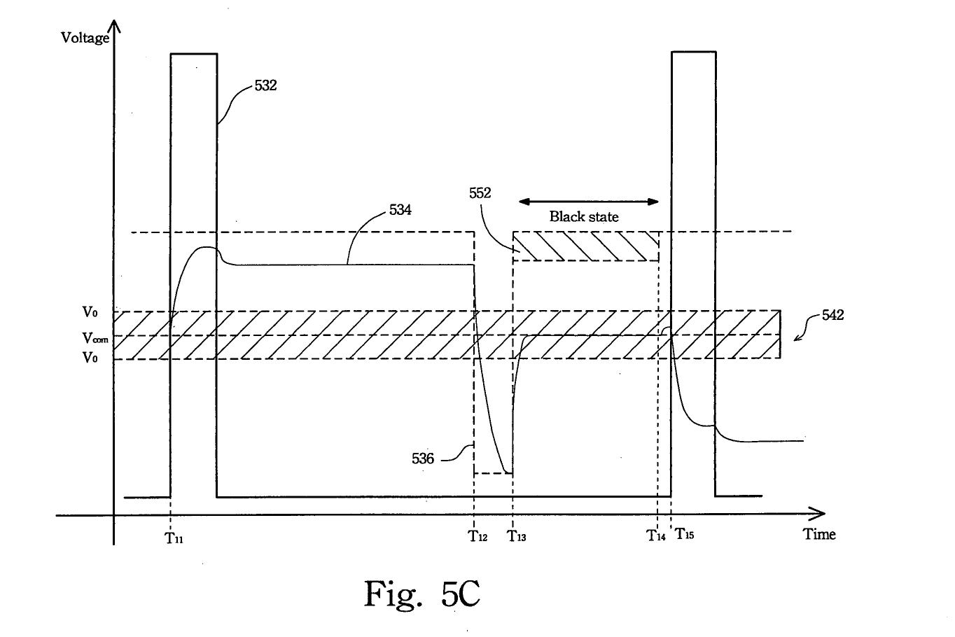

FIG. 5A illustrates a circuit diagram of another preferred embodiment of the invention. A scanning line 502 periodically switches a switching transistor 512 with enable pulses. When the switching transistor 512 is switched on, a data line 504 writes pixel data into a pixel cell 514 through the switching transistor 512.

A first electrode of the pixel cell 514 is connected to the switching transistor 512, and a second electrode of the pixel cell 514 is connected to the common voltage (V_{com}). Furthermore, one electrode of a storage capacitor 516 is connected to the switching transistor 512, and the other electrode of the storage capacitor 516 is connected to a black image line 508 of the invention.

The invention adds a black image transistor 518a and a black image line 508 into the foregoing circuit. A gate and a source of the black image transistor 518a are both connected to the first electrode of the pixel cell 514, and a drain of the black image transistor 518a is connected to the black image line 508.

By this configuration, the black image transistor 518a in circuit is equivalent to a diode 518b, as illustrated in FIG. 5B. When a black image enable pulse is sent from the black image line 508 to the diode 518b (i.e. the drain of the black image transistor 518a), and the voltage of the black image enable pulse is lower than the voltage of the pixel data, the diodes 518b thus are turned on.

The voltage of the black image line 508 then couples with the voltage of the first electrode of the pixel cell 514, so as to pull the voltage of the first electrode of the pixel cell 514 to a black image voltage range and the pixel cell 514 therefore presents a dark state. The black image voltage range is defined as being between the common voltage V_{com} plus a zero-level gray scale voltage and the common voltage V_{com} minus the zero-level gray scale voltage.

This preferred embodiment also provides a gate driver IC as illustrated in FIG. 3B. The gate driver IC controls the switching transistor 512 and black image transistor 518a through the scanning line 502 and the black image line 508, respectively. The gate driver IC 320 has gate pins 322 (G₁-Gₙ) and black image pins 328 (Bl₁-Blₙ). The gate pin 322 is connected to the scanning line 502 to switch the switching transistor 512, and the black image pin 328 is connected to the black image line 508 to switch the black image transistor 518a and modify the gate voltage.

The gate driver IC 320 respectively sends two enable pulses from the gate pins 322 and the black image pins 328, and a black image enable pulse of the black image line 508 is between two adjacent enable pulses of the scanning line 502. In addition, the gate driver IC 320 also can control the voltages of the scanning line 502 and the black image line 508.

However, the black image insertion circuit for display is not limited to operation with the gate driver IC as exemplified in this embodiment; other gate driver ICs also can be used in this invention if they can send a black image enable pulse of the black image line 508 between two adjacent enable pulses of the scanning line 502 and control the voltages of the black image line 508 and scanning line 502.

FIG. 5C is a graph of voltage versus time in accordance with one embodiment as exemplified by the circuit in FIG. 5A during operation. The following descriptions refer to FIG. 5C and FIG. 5A. At time T₁₁, a voltage signal 532 of the scanning line 502 sends an enable pulse to switch on the switching transistor 512, the data line 504 then sends the pixel data to the first electrode of the pixel cell 514 though the switching transistor 512 and a voltage signal 534 of the first electrode is raised to the voltage of the pixel data.

It is noted that the black image transistor 518a in the circuit is equivalent to the diode 518b. The voltage signal 536 therefore must be higher than the voltage signal 534 of the first electrode so as to prevent the black image transistor 518a (i.e. the diode 518b) from being be turned on.

At time T₁₂, a voltage signal 536 of the black image line 508 sends a black image enable pulse to switch on the black image transistor 518, and the voltage of the black image enable pulse must be lower than the voltage of the pixel data. As stated above, the black image transistor 518a in the circuit is equivalent to the diode 518b, the diode 518b is therefore turned on, and then the voltage signal 534 of the first electrode is then discharged to about the voltage signal 536 of the black image line 508.

At time T₁₃, the voltage signal 534 of the first electrode is coupled to a black image voltage range 542 by the voltage signal 536 of the black image line 508. The pixel cell 514 thereby presents a black state. The black image voltage range 542 is defined as being between the common voltage V_{com} plus a zero-level gray scale voltage and the common voltage V_{com} minus the zero-level gray scale voltage.

As illustrated in FIG. 5C, at time T₁₃, the voltage signal 536 of the black image line 508 in this embodiment couples the voltage signal 534 of the first electrode to a black image voltage range 542. However, in some cases, the voltage of the voltage signal 536 may be unable to return to the original voltage (as illustrated by area 552 in FIG. 4C) before the starting time point of a next enable pulse of the voltage signal 532 (at time T₁₅). Therefore, the gate driver IC 320 has to return the voltage of the black image line 508 to the origin voltage at time T₁₄.

At time T₁₅, the voltage signal 532 of the scanning line 502 sends the next enable pulse to switch on the switching transistor 512 again, and the data line 504 then sends the next pixel data to the first electrode of the pixel cell 514 through the switching transistor 512. Generally, the period of the two starting time points of the two adjacent enable pulses sent by the voltage signal 532 is called a frame time.

The foregoing black image enable pulse (at time T₁₂) sent by the voltage signal 536 of the black image line 508 must be between the two adjacent enable pulses (at time T₁₁ and time T₁₅) sent by the voltage signal 532 of the scanning line 502. In addition, the time T₁₄ that the voltage signal 536 modified must be earlier than the starting time point of the next enable pulse of the voltage signal 532 (at time T₁₅). All circuit conditions are therefore kept the same before any pixel data are sent to the liquid crystal pixel 500.

The invention has some advantages as followings:

1. The invention is carried out only with one gate driver IC and one data driver IC, and the frequencies of these two driver ICs need not be raised. The invention therefore can prevent the problem of difficulty in producing the ICs because of their high frequency.

2. The starting time point of the black image enable pulse that makes the pixel cell present a dark state can be arbitrarily adjusted, so the black-insert-ratio is not fixed at 50% as in the prior art. Liquid crystal displays utilizing the invention do not sacrifice half their brightness, and the invention therefore can improve the efficiencies of the liquid crystal displays.

3. The circuit design in the invention is simple and adjustable; moreover, the invention is also useful for large-sized liquid crystal displays having heavy RC delay and high-resolution liquid crystal displays having too many data lines. The invention provides a black image insertion method and apparatus suitable for large-sized or high-resolution liquid crystal displays.

It will be apparent to those skilled in the art that various modifications and variations can be made to the structure of the present invention without departing from the scope or spirit of the invention. In view of the foregoing, it is intended that the present invention cover modifications and variations of this is invention provided they fall within the scope of the following claims and their equivalents.

What is claimed is:

1. A black image insertion method for display, a black image being inserted between two frames of a liquid crystal display, each of the frames being displayed by a plurality of liquid crystal cells, each of the crystal cells having a first electrode and a second electrode, the first electrode being connected to a switching transistor, a plurality of enable pulses periodically switching the switching transistor, the first electrode being connected to a black image electronic element, and the second electrode being connected to a common voltage, the black image insertion method comprising:
sending one of the enable pulses to switch on the switching transistor, a voltage of the first electrode being changed to a data voltage; and
sending a black image enable pulse to switch on the black image electronic element before a next enable pulse switches on the switching transistor again, the voltage of the first electrode being changed from the data voltage to a black image voltage.

2. The black image insertion method of claim 1, wherein the black image voltage is between the common voltage plus a zero-level gray scale voltage and the common voltage minus the zero-level gray scale voltage.

3. The black image insertion method of claim 1, wherein the black image insertion method further comprises:
providing an initial voltage to the black image electronic element to turn off the black image electronic element during sending the enable pulse to switch on the switching transistor.

4. The black image insertion method of claim 3, wherein the black image insertion method further comprises:
returning a voltage of the black image electronic element to the initial voltage after the voltage of the first electrode is changed from the data voltage to the black image voltage.

5. The black image insertion method of claim 1, wherein the black image electronic element comprises a black image transistor.

6. The black image insertion method of claim 5, wherein the black image insertion method further comprises:
providing an initial voltage to the black image transistor to turn off the black image transistor during sending the enable pulse to switch on the switching transistor.

7. The black image insertion method of claim 6, wherein when a source and a gate of the black image transistor are connected to the initial voltage and a drain of the black image transistor is connected to the first electrode, the initial voltage is lower than the data voltage and the black image enable pulse is higher than the data voltage.

8. The black image insertion method of claim 6, wherein when a source and a gate of the black image transistor are connected to the first electrode and a drain of the black image transistor is connected to the initial voltage, the initial voltage is higher than the data voltage and the black image enable pulse is lower than the data voltage.

9. A black image insertion circuit for display, the black image insertion circuit for display comprising:
a switching transistor;
a liquid cell having a first electrode and a second electrode;
a scan line switching the switching transistor;
a data line sending pixel data to the first electrode through the switching transistor;
a common line, wherein a voltage of the common line is equal to a voltage of the second electrode;
a storage capacitor connecting the first electrode and the common line, wherein the storage capacitor stores the pixel data;
a black image transistor, wherein a drain of the black image transistor is connected to the first electrode and a source of the black image transistor is connected to the common line; and
a black image line, wherein the black image line is connected to a gate of the black image transistor to switch the black image transistor.

10. The black image insertion circuit of claim 9, wherein the black image insertion circuit further comprises a gate driver IC, and the gate driver IC comprises:
at least one first pin connected to the scan line, the first pin sending a first signal to switch the switching transistor; and
at least one second pin connected to the black image line, the second pin sending a second signal to switch the black image transistor, wherein a predetermined time offset exists between the first signal and the second signal.

11. The black image insertion circuit of claim 10, wherein periods of the first signal and the second signal are equal.

12. The black image insertion circuit of claim 10, wherein periods of the first signal and the second signal are unequal.

13. A black image insertion circuit for display, the black image insertion circuit for display comprising:
a switching transistor;
a liquid cell having a first electrode and a second electrode, wherein a voltage of the second electrode is equaled to a common voltage;
a scan line switching of the switching transistor;
a data line sending pixel data to the first electrode through the switching transistor;
a black image electronic element, wherein the black image electronic element is connected to the first electrode;
a black image line sending a black image data to the first electrode through the black image electronic element; and
a storage capacitor connecting the first electrode and the black image line, wherein the storage capacitor stores the pixel data.

14. The black image insertion circuit of claim 13, wherein the black image electronic element comprises a black image transistor.

15. The black image insertion circuit of claim 14, wherein a source and a gate of the black image transistor are connected to the black image line, and a drain of the black image transistor is connected to the first electrode.

16. The black image insertion circuit of claim 14, wherein a source and a gate of the black image transistor are connected to the first electrode, and a drain of the black image transistor is connected to the black image line.

17. The black image insertion circuit of claim 13, wherein the black image insertion circuit further comprises a gate driver IC, and the gate driver IC comprises:
at least one first pin connected to the scan line, the first pin sending an enable signal to switch the switching transistor; and
at least one second pin connected to the black image line, the second pin sending the black image data to the black image line, wherein a predetermined time offset exists between the enable signal and the black image data.

18. The black image insertion circuit of claim 17, wherein periods of the enable signal and the black image data are equal.

19. The black image insertion circuit of claim 17, wherein periods of the enable signal and the black image data are unequal.

20. A gate driver IC for a liquid crystal display, driving at least one liquid crystal pixel, the liquid crystal pixel having a switching transistor and a black image line, the gate driver IC for a liquid crystal display comprising:
at least one first pin connected to a gate of the switching transistor, wherein the first pin sends a first signal to switch the switching transistor; and
at least one second pin connected to the black image line, wherein the second pin sends a second signal to the black image line to display a black image on the crystal pixel, and wherein a predetermined time offset exists between the first signal and the second signal.

21. The black image insertion circuit of claim 20, wherein periods of the first signal and the second signal are equal.

22. The black image insertion circuit of claim 20, wherein periods of the first signal and the second signal are unequal.
